(19) United States
(12) Patent Application Publication
(10) Pub. No.: US 2011/0035490 A1
(43) Pub. Date: Feb. 10, 2011

(54) METHOD, SYSTEM AND CONNECTIVITY SERVICE NETWORK (CSN) FOR REALIZING LOCATION SERVICE

(76) Inventors: Hui Ni, Shenzhen (CN); Shiyong Tan, Shenzhen (CN); Yan Li, Shenzhen (CN)

Correspondence Address: Huawei/BHGL, P.O. Box 10395, Chicago, IL, 60610, US

(21) Appl. No.: 12/907,761

(22) Filed: Oct. 19, 2010

Related U.S. Application Data
(63) Continuation of application No. PCT/CN2009/071356, filed on Apr. 20, 2009.

(30) Foreign Application Priority Data
Apr. 24, 2008 (CN) 200810095750.6

(51) Int. Cl. G06F 15/173

(52) U.S. Cl. 709/224

(57) ABSTRACT

A method, a system, and a connectivity service network (CSN) for realizing a location service are provided. When a user terminal roams to the visited domain network from the home domain network, the H-CSN interacts with the V-CSN after receiving the location request, and obtains the location result through location control exercised by the V-CSN over the V-ASN, which realizes the location of the user terminal from the home domain network, and expands the application of the location service in the home domain network.

### CROSS-REFERENCE TO RELATED APPLICATIONS

This patent document is a continuation of International Application No. PCT/CN2009/071356, filed on Apr. 20, 2009, which claims priority to Chinese Patent Application No. 200810095750.6, filed on Apr. 24, 2008, both of which are hereby incorporated by reference in their entireties.

### FIELD OF THE TECHNOLOGY

The present disclose and embodiments relate to the field of communications technologies, and more particularly to a method, a system, and a connectivity service network (CSN) for realizing a location service.

### BACKGROUND

In a mobile communications network, the demands for value-added services based on location information of users, such as map navigation and localized advertising, grow increasingly. Value-added service providers can provide more localized and individualized service contents to the users according to the location information provided by the network. It can be known from the above description that, to realize the value-added services, the mobile communications network is required to have the capability of locating the user terminals.

Worldwide Interoperability for Microwave Access (WiMAX) defines a Location based Service (LBS) architecture, which is for providing locations of users (terminals) to services based on location information. This architecture includes an access service network (ASN), which is a group of function entities that provide wireless access to WiMAX user terminals, and consists of multiple access service network gateways (ASN-GWs) and base stations (BSs). The BSs are connected with mobile stations (MSs) and the ASN-GWs respectively; the ASN-GWs are connected with a connectivity service network (CSN) which is a group of function entities that provide IP connection and services to users; and the CSN is connected with clients which are external clients, terminals, or other internal function entities that initiate location requests. Moreover, the CSN includes a location server (LS), which is configured to provide network location function interfaces to the clients, receive the location requests initiated by the clients, and provide the obtained location information of user terminals in the network to the clients; the CSN further includes an authentication, authorization, and accounting (AAA) server, which is configured to authenticate a service according to user subscription data and operators' policies. The ASN-GWs include location controllers (LCs), which are configured to obtain the location information of user terminals and report the obtained location information to the LS. The BSs or the user terminals include location agents (LAs), which are configured to measure the location information of the user terminals according to location measurement instructions of the LCs.

Usually, the network that the user terminals belong to is called a home domain network, and the user terminals, when moving, may leave the home domain network and enter a visited domain network. FIG. 1 shows a network architecture based on a WiMAX roaming scenario, where the home domain network includes a home domain CSN (H-CSN), the visited domain network includes a visited domain CSN (V-CSN) and a visited domain ASN (V-ASN), and a user terminal roams to the visited domain network and accesses the V-ASN. No matter for the V-CSN, the V-ASN, or the H-CSN, function modules thereof are the same as those described in the previous LBS architecture, and will not be repeatedly described here. The H-CSN further includes an accounting server, which is configured to provide corresponding accounting capability to the location service. The ASN-GWs further include authenticators, which are configured to authenticate location requests.

According to the existing network architecture defined by the WiMAX LBS, when the user terminal roams to the visited domain network and accesses the V-ASN, the client can visit the location service through communication between the V-CSN and the V-ASN; however, when the client initiates a location request to the H-CSN, the H-CSN fails to locate the user terminal because the H-CSN cannot directly communicate with the V-ASN, which results in failure of the location service.

### SUMMARY

The present disclosure is directed to a method, a system, and a CSN for realizing a location service, so that a client can locate a user terminal through a home domain network when the user terminal roams to a visited domain network.

To realize the objective of the present disclosure, the present disclosure provides the following technical solutions.

A method for realizing a location service is provided, which includes:

receiving, by an H-CSN, a location request sent by a client;

sending the location request to a V-CSN after the location request is successfully authenticated;

receiving a location result returned by the V-CSN, where the location result is information obtained from location measurement by triggering a V-ASN after the V-CSN sends the location request to the V-ASN; and

sending the location result to the client.

A system for realizing a location service, including an H-CSN, a V-CSN, and a V-ASN, is provided, where:

the H-CSN is configured to receive a location request sent by a client, send the location request to the V-CSN after the location request is successfully authenticated, receive a location result returned by the V-CSN, and send the location result to the client;

the V-CSN is configured to send the location request to the V-ASN and receive the location result returned by the V-ASN; and

the V-ASN is configured to obtain a location result after triggering location measurement according to the location request sent by the V-CSN, and send the location result to the V-CSN.

A CSN, being an H-CSN that a user terminal belongs to, is provided, and includes:

a first receiving unit, configured to receive a location request sent by a client;

an authenticating unit, configured to authenticate the location request;

a first sending unit, configured to send the location request to a V-CSN after the authentication succeeds;

a second receiving unit, configured to receive a location result returned by the V-CSN, where the location result is information obtained from location measurement by triggering a V-ASN after the V-CSN sends the location request to the V-ASN; and

a second sending unit, configured to send the location result to the client.

As shown in the technical solutions provided by the above embodiments of the present disclosure, the H-CSN receives the location request sent by the client, sends the location request to the V-CSN after the location request is successfully authenticated, receives the location result returned by the V-CSN where the location result is the information obtained by the V-ASN from location measurement triggered according to the location request sent by the V-CSN, and sends the location result to the client. By implementing the embodiments of the present disclosure, when the user terminal roams to the visited domain network from the home domain network, the H-CSN interacts with the V-CSN after receiving the location request, and obtains the location result through location control exercised by the V-CSN over the V-ASN, which realizes the location of the user terminal from the home domain network, and expands the application of the location service in the home domain network when the user terminal is roaming.

### BRIEF DESCRIPTION OF THE DRAWINGS

FIG. 1 is a schematic view of a network architecture based on a WiMAX roaming scenario;

FIG. 2 is a flow chart of a method for realizing a location service according to an embodiment of the present disclosure;

FIG. 3 is a flow chart of a method for realizing a location service according to another embodiment of the present disclosure;

FIG. 4 is a flow chart of a method for realizing a location service according to another embodiment of the present disclosure;

FIG. 5 is a flow chart of a method for realizing a location service according to another embodiment of the present disclosure;

FIG. 6 is a flow chart of a method for realizing a location service according to another embodiment of the present disclosure;

FIG. 7 is a flow chart of a method for realizing a location service according to another embodiment of the present disclosure;

FIG. 8 is a flow chart of a method for realizing a location service according to another embodiment of the present disclosure;

FIG. 9 is a block diagram of a system for realizing a location service according to an embodiment of the present disclosure;

FIG. 10 is a block diagram of a CSN according to an embodiment of the present disclosure;

FIG. 11 is a block diagram of a CSN according to another embodiment of the present disclosure;

FIG. 12 is a block diagram of another CSN according to an embodiment of the present disclosure; and

FIG. 13 is a block diagram of another CSN another embodiment of according to the present disclosure.

### DETAILED DESCRIPTION OF THE EMBODIMENTS

The present disclosure provides a method, a system, and a CSN for realizing a location service, where an H-CSN receives a location request sent by a client, sends the location request to a V-CSN after the location request is successfully authenticated, receives a location result returned by the V-CSN, where the location result is information obtained from location measurement triggered by a V-ASN according to the location request sent by the V-CSN, and sends the location result to the client.

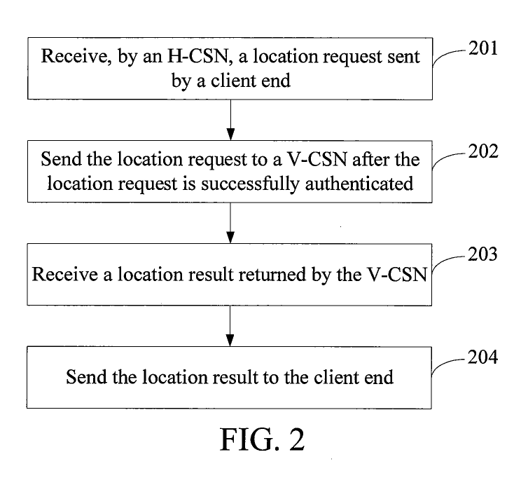

The process of the method according to an embodiment of the present disclosure is shown in FIG. 2.

Step 201: An H-CSN receives a location request sent by a client.

Step 202: The location request is sent to a V-CSN after the location request is successfully authenticated.

The sending the location request to the V-CSN includes: a home domain LS (H-LS) in the H-CSN sends the location request to a function entity in the V-CSN; or the H-LS in the H-CSN forwards the location request to the function entity in the V-CSN through a home domain AAA (H-AAA) server. The function entity in the V-CSN may be a visited domain LS (V-LS) or a visited domain AAA (V-AAA) server.

Step 203: A location result returned by the V-CSN is received.

Specifically, the location result is information obtained by the V-ASN from location measurement triggered according to the location request sent by the V-CSN.

The modes by which the V-CSN sends the location request to the V-ASN include: the V-LS in the V-CSN obtains an identification of a visited domain LC (V-LC) in the V-ASN from an authenticator in the V-ASN, and sends the location request to the V-LC according to the identification of the V-LC; or the LS in the V-CSN sends the location request to the V-LC through the V-AAA server in the V-CSN and the authenticator in the V-ASN.

The receiving the location result returned by the V-CSN includes: The H-LS in the H-CSN receives the location result returned by a function entity in the V-CSN; or the H-LS in the H-CSN receives the location result, which is returned by the function entity in the V-CSN through the H-AAA server. The function entity in the V-CSN may be the V-LS or the V-AAA server.

Step 204: The location result is sent to the client.

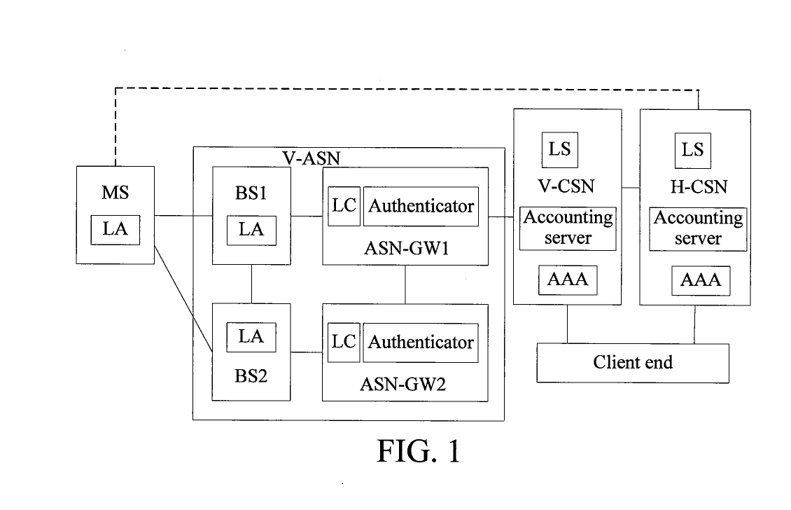

Hereinafter, the technical solutions provided by the embodiments of the present disclosure will be described in detail with reference to a schematic view of a roaming network architecture in FIG. 1, so that persons skilled in the art can better understand the technical solutions of the present disclosure.

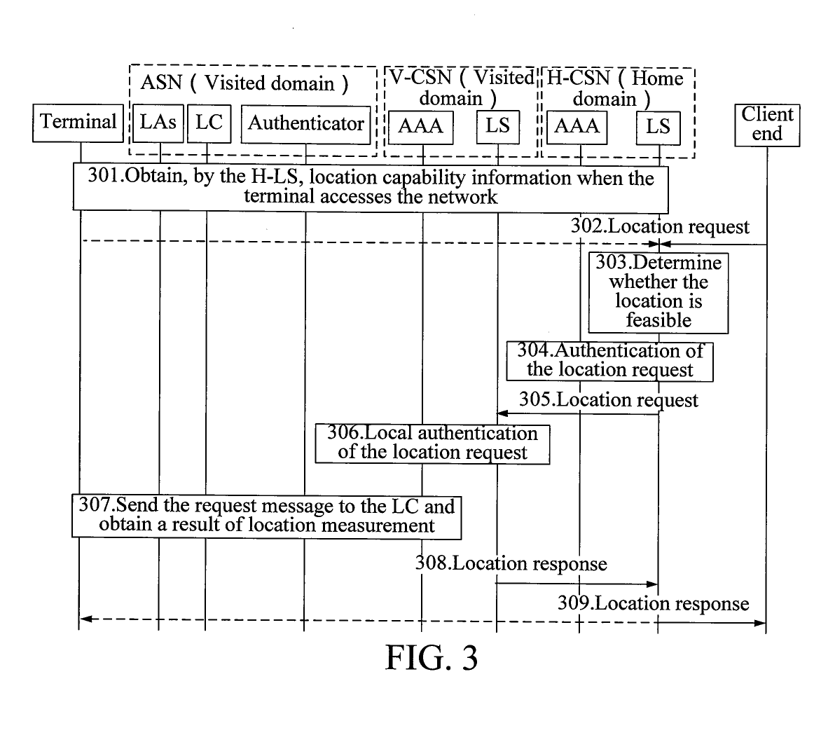

The process of the method for realizing a location service of according to another embodiment of the present disclosure is shown in FIG. 3. This embodiment shows a process that a location request and a location response are directly transmitted between an H-LS and a V-LS, and the V-LS instructs a V-LC to perform location measurement.

Step 301: When a terminal accesses a network or when a V-ASN switches, the H-LS obtains location capability information. The location capability information may include at least one of: location capability of the terminal, location capability of the V-ASN, and location capability of a V-CSN, and may be sent to the H-LS through an authentication message.

Step 302: A client sends a location request to the H-LS. The request may include an identification of the terminal to be located and required Quality of Service (QoS) values for location (regarding horizontal accuracy, vertical accuracy, and location delay). If a periodic location is required, the location request may further include a location period.

Step 303: The H-LS determines, according to the location capability information of the visited domain network, whether the location capability information satisfies the location request, and if the location capability information satisfies the location request, step 304 is performed; if the location capability information does not satisfy the location, a location failure response is returned to the client.

Step 304: The H-LS authenticates the location request through an H-AAA server. The authentication includes the process of authentication and authorization of the client, an LBS server, and the terminal. If the authentication succeeds, step 305 is performed; if the authentication fails, a location failure response is returned to the client.

Step 305: The H-LS forwards the location request sent by the client to the V-LS.

Step 306: The V-LS authenticates the location request locally through the V-AAA server. The authentication may be accomplished according to a state of the client, a local policy, or the network. If the authentication succeeds, step 307 is performed; if the authentication fails, a location failure response is forwarded to the client through the H-LS.

Step 307: The V-LS sends the location request to the V-LC to trigger the network to perform location measurement and obtain location measurement information.

The sending the location request to the LC includes two modes: The V-LS obtains an address of the V-LC through an authenticator, and directly sends the location request to the V-LC according to the address; or the LS forwards the location request to the V-LC through the V-AAA server and the authenticator. It should be noted that, the above local authentication in step 306 and the forwarding of the location request in step 307 may be combined and performed in one step.

Step 308: The V-LS calculates, according to the obtained location measurement information, to get a location result, and sends a location response containing the location result to the H-LS.

Step 309: The H-LS forwards the received location response to the client.

It should be noted that, if the location request sent by the H-LS in step 305 is a periodical location request, the V-LC repeats steps 307 to 309 according to location period information in the request message until it receives a location termination message sent by the H-LS.

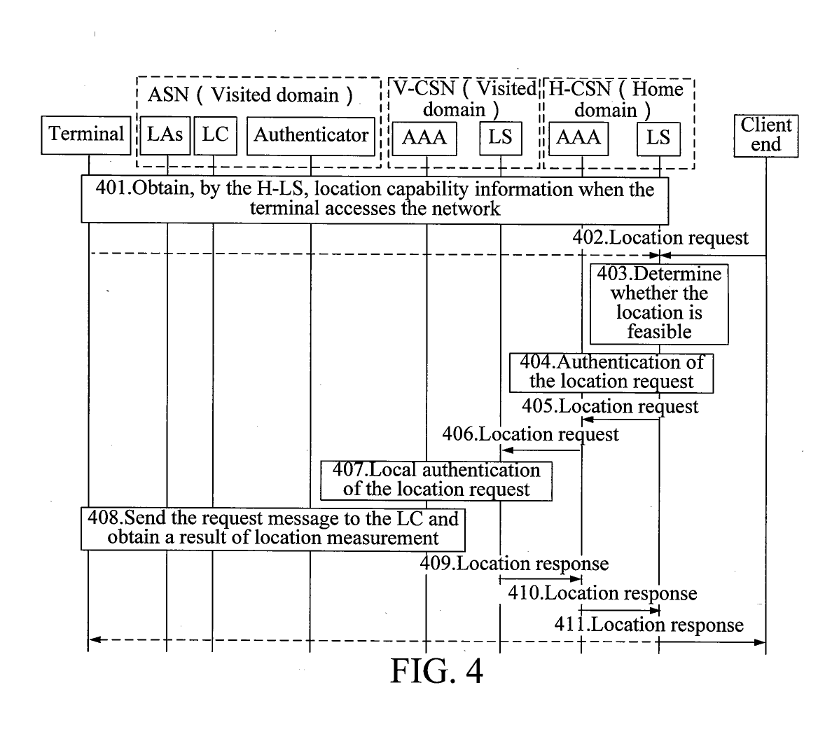

The process of another embodiment of the method for realizing a location service of the present disclosure is shown in FIG. 4. Th is embodiment shows a process where a location request and a location response are transmitted through an H-AAA server between an H-LS and a V-LS, and the V-LS instructs a V-LC to perform location measurement.

Step 401: When a terminal accesses a network or when a V-ASN switches, the H-LS obtains location capability information. The location capability information may include at least one of: location capability of the terminal, location capability of the V-ASN, and location capability of a V-CSN, and may be sent to the H-LS through an authentication message.

Step 402: A client sends a location request to the H-LS. The request may include an identification of the terminal to be located and required QoS values for location (regarding horizontal accuracy, vertical accuracy, and location delay). If a periodic location is required, the location request may further include a location period.

Step 403: The H-LS determines, according to the location capability information of the visited domain network, whether the location request is satisfied, and if the location request is satisfied, step 404 is performed; if the location request is not satisfied, a location failure response is returned to the client.

Step 404: The H-LS authenticates the location request through the H-AAA server. The authentication includes the process of authentication and authorization of the client, an LBS server, and the terminal. If the authentication succeeds, step 405 is performed; if the authentication fails, a location failure response is returned to the client.

Step 405: The H-LS forwards the location request sent by the client to the H-AAA server.

It should be noted that, the authentication of the location request in step 404 and the forwarding of the location request in step 405 may be combined and performed in one step. That is, the H-AAA server authenticates the location request message before forwarding it. If the authentication succeeds, step 406 is performed; if the authentication fails, a location failure response is forwarded to the client through the H-LS.

Step 406: The H-AAA server forwards the location request to the V-LS.

Step 407: The V-LS authenticates the location request locally through the V-AAA server. The authentication may be accomplished according to a state of the client, a local policy, or the network. If the authentication succeeds, step 408 is performed; if the authentication fails, a location failure response is forwarded to the client through the H-LS.

Step 408: The V-LS sends the location request to the V-LC to trigger the network to perform location measurement and obtain location measurement information.

The sending the location request to the LC includes two modes: The V-LS obtains an address of the V-LC through an authenticator, and directly sends the location request to the V-LC according to the address; or the LS forwards the location request to the V-LC through the V-AAA server and the authenticator. It should be noted that, the above local authentication in step 407 and the forwarding of the location request in step 408 may be combined and performed in one step.

Step 409: The V-LS calculates, according to the obtained location measurement information, to get a location result, and sends a location response containing the location result to the H-AAA server.

Step 410: The H-AAA server forwards the location response to the H-LS.

Step 411: The H-LS forwards the received location response to the client.

It should be noted that, if the location request sent by the H-LS in step 405 is a periodical location request, the V-LC repeats steps 408 to 411 according to location period information in the request message until it receives a location termination message sent by the H-LS.

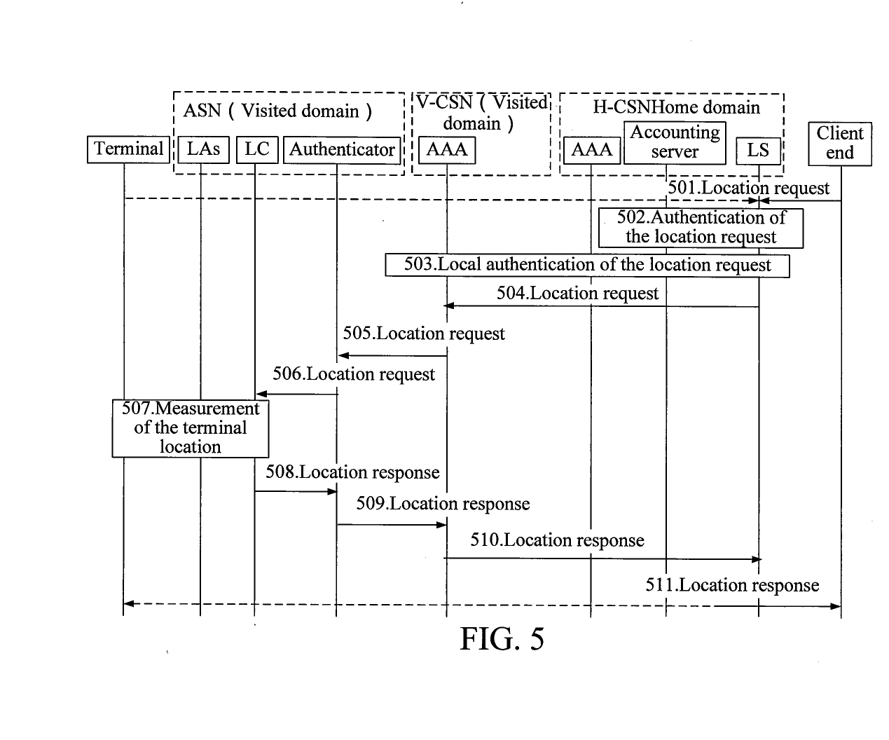

The process of another embodiment of the method for realizing a location service of the present disclosure is shown in FIG. 5. Th is embodiment shows a process where after an H-LS accomplishes authentication of a request through an H-AAA server and a V-AAA server respectively, the V-AAA server and an authenticator forward the location request and a location response.

Step 501: A client sends a location request to the H-LS. The request may include an identification of a terminal to be located and required QoS values for location (regarding horizontal accuracy, vertical accuracy, and location delay). If a periodic location is required, the location request may further include a location period.

Step 502: The H-LS authenticates the location request through the H-AAA server. The authentication includes the process of authentication and authorization of the client, an LBS server, and the terminal. If the authentication succeeds, step 503 is performed; if the authentication fails, a location failure response is returned to the client.

Step 503: The H-LS authenticates the location request locally through the V-AAA server. The authentication may be accomplished according to a state of the client, a local policy, or a network. If the authentication succeeds, step 504 is performed; if the authentication fails, a location failure response is forwarded to the client through the H-LS.

Step 504: The H-LS forwards the location request sent by the client to the V-AAA server.

It should be noted that, the above authentication of the location request in step 503 and the forwarding of the location request in step 504 may be combined and performed in one step. That is, the V-AAA server authenticates the location request message before forwarding it. If the authentication succeeds, step 505 is performed; if the authentication fails, a location failure response is forwarded to the client through the H-LS.

Step 505: The V-AAA server forwards the location request sent by the H-LS to the authenticator.

Step 506: The authenticator forwards the location request sent by the V-AAA server to the V-LC.

Step 507: The authenticator sends the location request to the V-LC to trigger the network to perform location measurement and obtain location measurement information.

Step 508: The V-LC calculates, according to the obtained location measurement information, to get a location result, and sends a location response containing the location result to the authenticator. The location response may further include an indication showing whether the location is successful or not.

Step 509: The authenticator forwards the received location response to the V-AAA server.

Step 510: The V-AAA server forwards the received location response to the H-LS.

Step 511: The H-LS forwards the received location response to the client.

It should be noted that, if the location request sent by the H-LS in step 504 is a periodical location request, the V-LC repeats steps 507 to 511 according to location period information in the request message until it receives a location termination message sent by the H-LS.

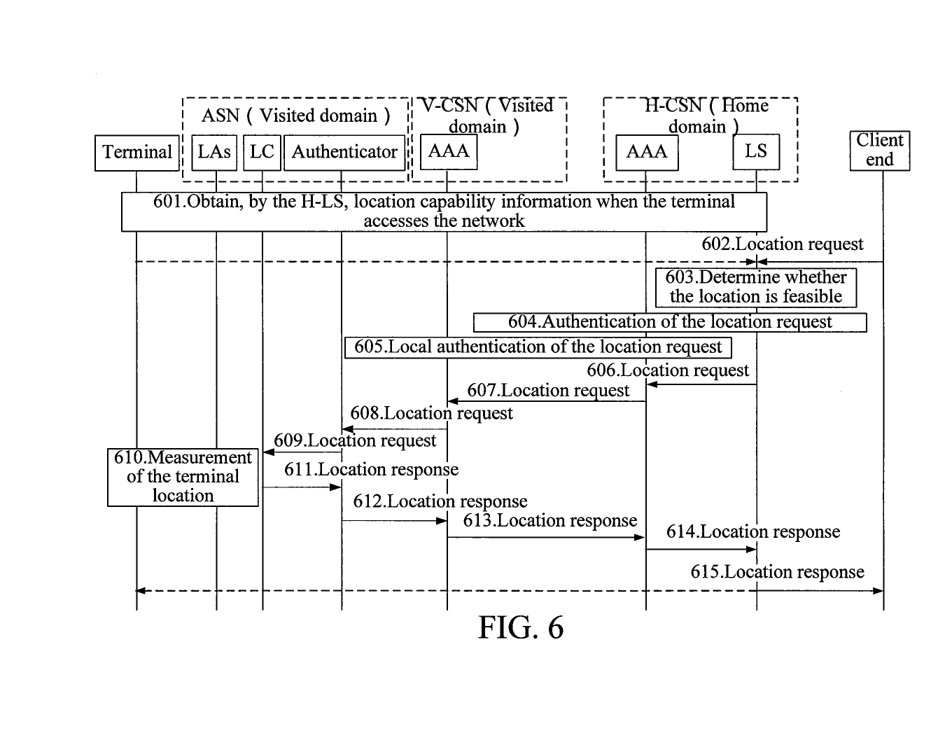

The process of the method for realizing a location service according to another embodiment of the present disclosure is shown in FIG. 6. This embodiment shows a process that after an H-LS accomplishes authentication of a request through an H-AAA server and a V-AAA server respectively, the V-AAA server and an authenticator forward the location request and a location response.

Step 601: When a terminal accesses a network, the H-LS obtains location capability information. The location capability information may include at least one of: location capability of the terminal, location capability of a V-ASN, and location capability of a V-CSN, and may be sent to the H-LS through an authentication message.

Step 602: A client sends a location request to the H-LS. The request may include an identification of the terminal to be located and required QoS values for location (regarding horizontal accuracy, vertical accuracy, and location delay). If a periodic location is required, the location request may further include a location period.

Step 603: The H-LS determines, according to the location capability information of the visited domain network, whether the location request is satisfied, and if the location request is satisfied, step 604 is performed; if the location request is not satisfied, a location failure response is returned to the client.

Step 604: The H-LS authenticates the location request through the H-AAA server. The authentication includes the process of authentication and authorization of the client, an LBS server, and the terminal. If the authentication succeeds, step 605 is performed; if the authentication fails, a location failure response is returned to the client.

Step 605: The H-AAA server authenticates the location request locally through the V-AAA server. The authentication may be accomplished according to a state of the client, a local policy, or the network. If the authentication succeeds, step 606 is performed; if the authentication fails, a location failure response is forwarded to the client through the H-LS.

Step 606: The H-LS forwards the location request sent by the client to the H-AAA server.

It should be noted that, the above authentication of the location request in step 604 and the forwarding of the location request in step 606 may be combined and performed in one step. That is, the H-AAA server authenticates the location request message before forwarding it. If the authentication succeeds, step 607 is performed; if the authentication fails, a location failure response is forwarded to the client through the H-LS.

Step 607: The H-AAA server forwards the location request sent by the H-LS to the V-AAA server.

It should be noted that, the above authentication of the location request in step 605 and the forwarding of the location request in step 607 may be combined and performed in one step. That is, the V-AAA server authenticates the location request message before forwarding it. If the authentication succeeds, step 608 is performed; if the authentication fails, a location failure response is forwarded to the client through the H-LS.

Step 608: The V-AAA server forwards the location request sent by the H-AAA server to the authenticator.

Step 609: The authenticator forwards the location request sent by the V-AAA server to the V-LC.

Step 610: The authenticator sends the location request to the V-LC to trigger the network to perform location measurement and obtain location measurement information.

Step 611: The V-LC calculates, according to the obtained location measurement information, to get a location result, and sends a location response containing the location result to the authenticator. The location response may further include an indication showing whether the location is successful or not.

Step 612: The authenticator forwards the received location response to the V-AAA server.

Step 613: The V-AAA server forwards the received location response to the H-AAA server.

Step 614: The H-AAA server forwards the received location response to the H-LS.

Step 615: The H-LS forwards the received location response to the client.

It should be noted that, if the location request sent by the H-LS in step 606 is a periodical location request, the V-LC repeats steps 610 to 615 according to location period information in the request message until it receives a location termination message sent by the H-LS.

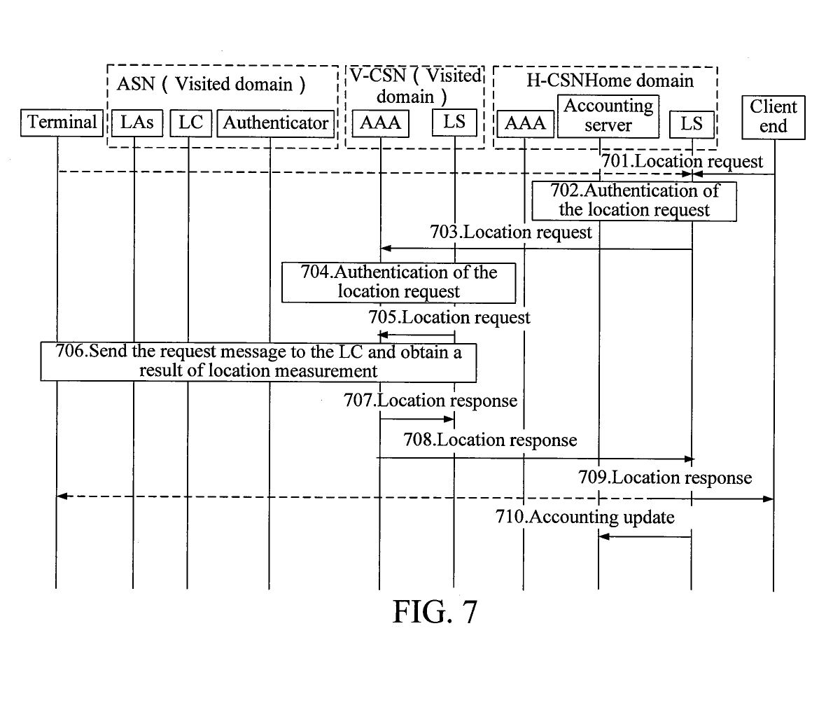

The process of another embodiment of the method for realizing a location service of the present disclosure is shown in FIG. 7. This embodiment shows a process where an H-LS directly sends a location request to a V-AAA server, the V-AAA server instructs, through a V-LS, a V-LC to perform location measurement, and the H-LS requests accounting update from a home domain accounting server.

Step 701: A client sends a location request to the H-LS. The request may include an identification of a terminal to be located and required QoS values for location (regarding horizontal accuracy, vertical accuracy, and location delay). If a periodic location is required, the location request may further include a location period.

Step 702: The H-LS authenticates the location request through an H-AAA server. The authentication includes the process of authentication and authorization of the client, an LBS server, and the terminal. If the authentication succeeds, step 703 is performed; if the authentication fails, a location failure response is returned to the client.

Step 703: The H-LS forwards the location request sent by the client to the V-AAA server.

Step 704: The V-AAA server authenticates the location request locally. The authentication may be accomplished according to a state of the client, a local policy, or a network. If the authentication succeeds, step 705 is performed; if the authentication fails, a location failure response is forwarded to the client through the H-LS.

Step 705: The V-AAA server forwards the location request sent by the H-LS to the V-LS.

Step 706: The V-LS sends the location request to the V-LC to trigger the network to perform location measurement and obtain location measurement information.

The sending the location request to the LC includes two modes: The V-LS obtains an address of the V-LC through an authenticator, and directly sends the location request to the V-LC according to the address; or the LS forwards the location request to the V-LC through the V-AAA server and the authenticator. It should be noted that, the above local authentication in step 704 and the forwarding of the location request in step 705 and step 706 may be combined and performed in one step.

Step 707: The V-LS calculates, according to the obtained location measurement information, to get a location result, and sends a location response containing the location result to the V-AAA server.

Step 708: The V-AAA server forwards the received location response to the H-LS.

Step 709: The H-LS forwards the received location response to the client.

Step 710: The H-LS sends an accounting update message to a home domain accounting server to request the accounting server to charge the location request.

It should be noted that, if the location request sent by the H-LS in step 703 is a periodical location request, the V-LC repeats steps 706 to 709 according to location period information in the request message until it receives a location termination message sent by the H-LS.

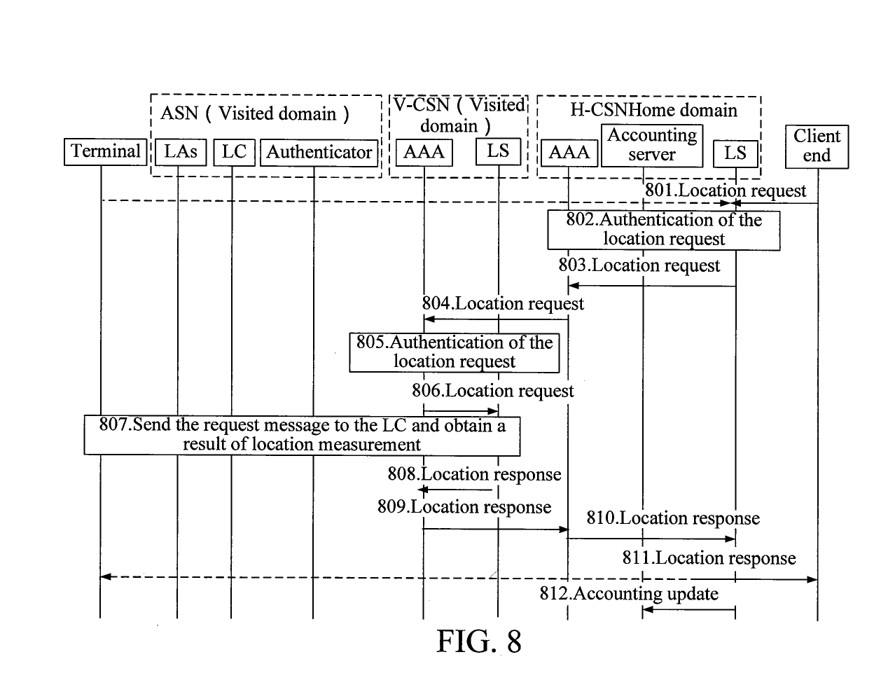

The process of another embodiment of the method for realizing a location service of the present disclosure is shown in FIG. 8. This embodiment shows a process that a location request and a location response are transmitted through an H-AAA server between an H-LS and a V-LS, and the H-LS requests accounting update from a home domain accounting server.

Step 801: A client sends a location request to the H-LS. The request may include an identification of a terminal to be located and required QoS values for location (regarding horizontal accuracy, vertical accuracy, and location delay). If a periodic location is required, the location request may further include a location period.

Step 802: The H-LS authenticates the location request through the H-AAA server. The authentication includes the process of authentication and authorization of the client, an LBS server, and the terminal. If the authentication succeeds, step 803 is performed; if the authentication fails, a location failure response is returned to the client.

Step 803: The H-LS forwards the location request sent by the client to the H-AAA server.

Step 804: The H-AAA server forwards the location request sent by the H-LS to the V-AAA server.

Step 805: The V-AAA server authenticates the location request locally. The authentication may be accomplished according to a state of the client, a local policy, or a network. If the authentication succeeds, step 806 is performed; if the authentication fails, a location failure response is forwarded to the client through the H-LS.

Step 806: The V-AAA server forwards the location request sent by the H-LS to the V-LS.

Step 807: The V-LS sends the location request to a V-LC to trigger the network to perform location measurement and obtain location measurement information.

The sending the location request to the LC includes two modes: The V-LS obtains an address of the V-LC through an authenticator, and directly sends the location request to the V-LC according to the address; or the LS forwards the location request to the V-LC through the V-AAA server and the authenticator. It should be noted that, the above local authentication in step 805 and the forwarding of the location request in step 806 and step 807 may be combined and performed in one step.

Step 808: The V-LS calculates, according to the obtained location measurement information, to get a location result, and sends a location response containing the location result to the V-AAA server.

Step 809: The V-AAA server forwards the received location response to the H-AAA server.

Step 810: The H-AAA server forwards the received location response to the H-LS.

Step 811: The H-LS forwards the received location response to the client.

Step 812: The H-LS sends an accounting update message to a home domain accounting server to request the accounting server to charge the location request.

It should be noted that, if the location request sent by the H-LS in step 803 is a periodical location request, the V-LC repeats steps 807 to 811 according to location period information in the request message until it receives a location termination message sent by the H-LS.

Corresponding to the embodiments of the method for realizing a location service of the present disclosure, the present disclosure also provides embodiments of a system for realizing a location service.

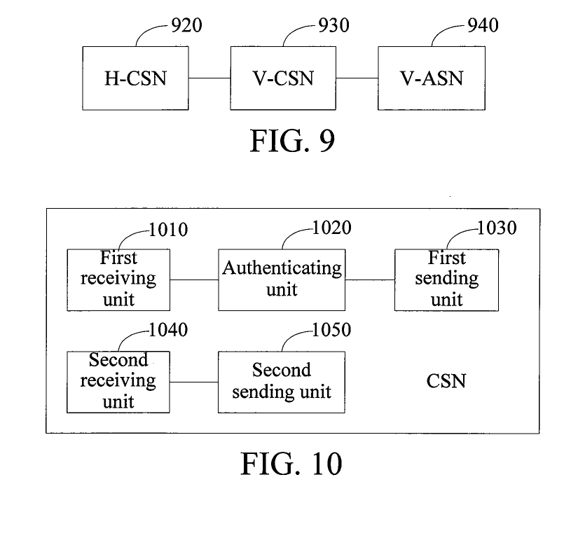

A block diagram of a system for realizing a location service according to an embodiment of the present disclosure is shown in FIG. 9. The system includes an H-CSN 920 that a user terminal belongs to, a V-CSN 930 that the user terminal roams to, and a V-ASN 940.

The H-CSN 920 is configured to receive a location request sent by a client, send the location request to the V-CSN 930 after the location request is successfully authenticated, receive a location result returned by the V-CSN 930, and send the location result obtained according to the location request to the client. The V-CSN 930 is configured to send the location request to the V-ASN 940 and receive the location result returned by the V-ASN 940. The V-ASN 940 is configured to obtain the location result after triggering location measurement according to the location request sent by the V-CSN 930, and send the location result to the V-CSN 930.

Corresponding to the embodiments of the method and the system for realizing a location service of the present disclosure, the present disclosure also provides embodiments of a CSN.

A block diagram of a CSN according to an embodiment of the present disclosure is shown in FIG. 10. The CSN is an H-CSN that a user terminal belongs to, and includes: a first receiving unit 1010, an authenticating unit 1020, a first sending unit 1030, a second receiving unit 1040, and a second sending unit 1050.

The first receiving unit 1010 is configured to receive a location request sent by a client. The authenticating unit 1020 is configured to authenticate the location request. The first sending unit 1030 is configured to send the location request to a V-CSN after the authentication succeeds. The second receiving unit 1040 is configured to receive a location result returned by the V-CSN, where the location result is information obtained by a V-ASN from location measurement triggered according to the location request sent by the V-CSN. The second sending unit 1050 is configured to send the location result to the client.

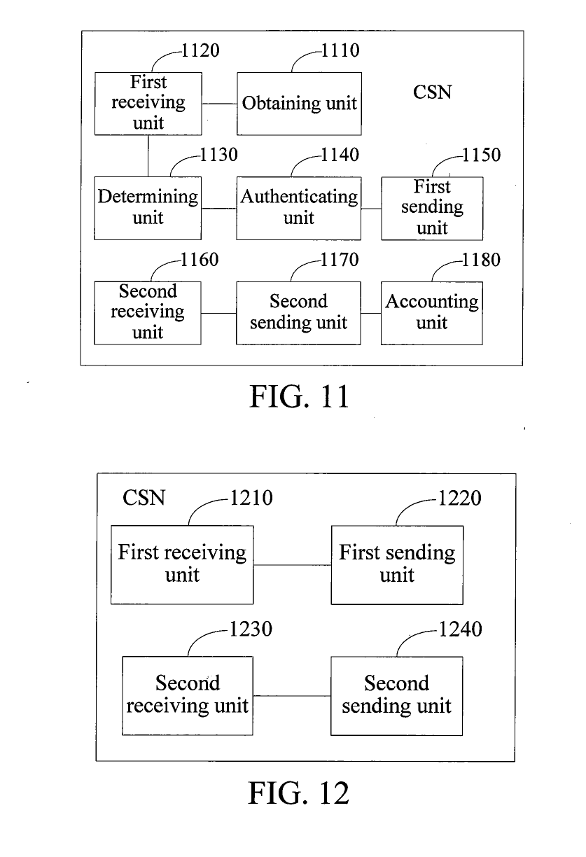

A block diagram of a CSN according to another embodiment of the present disclosure is shown in FIG. 11. The CSN is an H-CSN that the user terminal belongs to, and includes: an obtaining unit 1110, a first receiving unit 1120, a determining unit 1130, an authenticating unit 1140, a first sending unit 1150, a second receiving unit 1160, a second sending unit 1170, and an accounting unit 1180.

The obtaining unit 1110 is configured to obtain location capability information when a user terminal accesses a V-ASN or when the V-ASN switches, where the location capability information includes at least one of: location capability of the user terminal, location capability of the V-ASN, and location capability of a V-CSN. The first receiving unit 1120 is configured to receive a location request sent by a client. The determining unit 1130 is configured to determine, according to the location capability information, whether the location request is satisfied, and if the location request is satisfied, trigger the authenticating unit 1140 to authenticate the location request; if the location request is not satisfied, return that the location fails. The authenticating unit 1140 is configured to authenticate the location request. The first sending unit 1150 is configured to send the location request to the V-CSN after the authentication succeeds. The second receiving unit 1160 is configured to receive a location result returned by the V-CSN, where the location result is information obtained by the V-ASN from location measurement triggered according to the location request sent by the V-CSN. The second sending unit 1170 is configured to send the location result to the client. The accounting unit 1180 is configured to charge the location request according to a received accounting update request.

Moreover, when the location request received by the first receiving unit 1120 is a periodical location request, the second receiving unit 1160 is specifically configured to receive the location result returned by the V-CSN according to a period of the location request, where the location result is information obtained, by implementing the location measurement according to the period, after the V-ASN receives the periodical location request. The CSN also includes a terminating unit configured to send a location termination request to the V-CSN, and the location termination request is used for the V-ASN to terminate the location measurement after the V-ASN receives the location termination request forwarded by the V-CSN.

A block diagram of a CSN according to another embodiment of the present disclosure is shown in FIG. 12. The CSN is a V-CSN that a user terminal roams to, and includes: a first receiving unit 1210, a first sending unit 1220, a second receiving unit 1230, and a second sending unit 1240.

The first receiving unit 1210 is configured to receive a location request sent by an H-CSN. The first sending unit 1220 is configured to send the location request to a V-ASN. The second receiving unit 1230 is configured to receive a location result returned by the V-ASN, where the location result is information obtained by the V-ASN from location measurement triggered according to the location request. The second sending unit 1240 is configured to send the location result to the H-CSN.

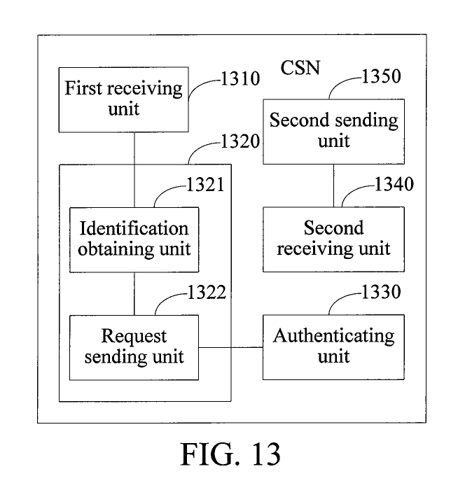

A block diagram of another CSN according to another embodiment of the present disclosure is shown in FIG. 13. The CSN is a V-CSN that a user terminal roams to, and includes: a first receiving unit 1310, a first sending unit 1320, an authenticating unit 1330, a second receiving unit 1340, and a second sending unit 1350.

The first receiving unit 1310 is configured to receive a location request sent by an H-CSN. The first sending unit 1320 is configured to send the location request to a V-ASN. The authenticating unit 1330 is configured to locally authenticate the location request. The second receiving unit 1340 is configured to receive a location result returned by the V-ASN, where the location result is information obtained by the V-ASN from location measurement triggered according to the location request. The second sending unit 1350 is configured to send the location result to the H-CSN.

The first sending unit 1320 includes an identification obtaining unit 1321 and a request sending unit 1322. The identification obtaining unit 1321 is configured to obtain, through a V-LS, an identification of a V-LC in the V-ASN from an authenticator in the V-ASN. The request sending unit 1322 is configured to send the location request to the V-LC according to the identification of the V-LC.

It can be seen from the above description that, by implementing the embodiments of the present disclosure, when the user terminal roams to the visited domain network from the home domain network, the H-CSN interacts with the V-CSN after receiving the location request, and obtains the location result through location control exercised by the V-CSN over the V-ASN, which realizes the location of the user terminal from the home domain network, and expands the application of the location service in the home domain network when the user terminal is roaming.

Persons of ordinary skill in the art may understand that all or part of the steps of the method according to the embodiments of the present disclosure may be implemented by a program instructing relevant hardware. The program may be stored in a computer readable storage medium. The execution of the program includes the following steps: receiving, by an H-CSN, a location request sent by a client; sending the location request to a V-CSN after the location request is successfully authenticated; receiving a location result returned by the V-CSN, where the location result is information obtained from location measurement by triggering a V-ASN after the V-CSN sends the location request to the V-ASN; and sending the location result to the client.

The storage medium may be a magnetic disk, a Compact Disk Read-Only Memory (CD-ROM), a Read-Only Memory (ROM) or a Random Access Memory (RAM).

Although the disclosure has been described through some exemplary embodiments, the disclosure is not limited to such embodiments. It is apparent that those skilled in the art can make various modifications and variations to the disclosure without departing from the spirit and scope of the disclosure. The appended claims of the disclosure are intended to cover those modifications and variations.

What is claimed is:

1. A method for realizing a location service, comprising:
receiving, by a home domain connectivity service network (H-CSN), a location request sent by a client;
sending the location request to a visited domain CSN (V-CSN) after the location request is successfully authenticated;
receiving a location result returned by the V-CSN, wherein the location result is information obtained from location measurement by triggering a visited domain access service network (V-ASN) after the V-CSN sends the location request to the V-ASN; and
sending the location result to the client.

2. The method according to claim 1, wherein after the receiving, by the H-CSN, the location request sent by the client, the method further comprises:
determining, by the H-CSN, according to location capability information, whether the location request is satisfied, and if the location request is satisfied, authenticating the location request; if the location request is not satisfied, returning that the location fails;
wherein when a user terminal accesses the V-ASN or when the V-ASN switches, the H-CSN obtains the location capability information, wherein the location capability information comprises at least one of: location capability of the user terminal, location capability of the V-ASN, and location capability of the V-CSN.

3. The method according to claim 1, wherein the sending the location request to the V-CSN comprises:
sending, by a home domain location server (H-LS) in the H-CSN, the location request to a function entity in the V-CSN; or
forwarding, by the H-LS in the H-CSN, the location request to the function entity in the V-CSN through a home domain authentication, authorization, and accounting (H-AAA) server, wherein
the function entity comprises a visited domain LS (V-LS) or a visited domain AAA (V-AAA) server.

4. The method according to claim 1, wherein the sending, by the V-CSN, the location request to the V-ASN comprises:
obtaining, by a V-LS in the V-CSN, an identification of a visited domain location controller (V-LC) in the V-ASN from an authenticator in the V-ASN, and sending the location request to the V-LC according to the identification of the V-LC; or
sending, by the LS in the V-CSN, the location request to the V-LC through a V-AAA server in the V-CSN and the authenticator in the V-ASN.

5. The method according to claim 4, further comprising: authenticating, by the V-AAA server, the location request locally, and if the authentication succeeds, performing the sending the location request to the V-LC; if the authentication fails, returning that the authentication fails.

6. The method according to claim 1, wherein the receiving the location result returned by the V-CSN comprises:
receiving, by an H-LS in the H-CSN, the location result returned by a function entity in the V-CSN; or
receiving, by the H-LS in the H-CSN, the location result, which is returned by the function entity in the V-CSN through an H-AAA server, wherein
the function entity comprises a V-LS or a V-AAA server.

7. The method according to claim 1, wherein
the location request is a periodical location request, and the receiving the location result returned by the V-CSN comprises: receiving the location result, which is returned by the V-CSN according to a period of the location request, wherein the location result is the information obtained by the V-ASN, in the way of implementing location measurement according to the period, after receiving the periodical location request; and
the method further comprises: sending a location termination request to the V-CSN, wherein the location termination request is used for the V-ASN to terminate the location measurement after the V-ASN receives the location termination request forwarded by the V-CSN.

8. The method according to claim 1, further comprising: charging the location request according to a received accounting update request.

9. A system for realizing a location service, comprising a home domain connectivity service network (H-CSN), a visited domain CSN (V-CSN), and a visited domain access service network (V-ASN), wherein
the H-CSN is configured to receive a location request sent by a client, send the location request to the V-CSN after the location request is successfully authenticated, receive a location result returned by the V-CSN, and send the location result to the client;
the V-CSN is configured to send the location request to the V-ASN and receive the location result returned by the V-ASN; and
the V-ASN is configured to obtain a location result after triggering location measurement according to the location request sent by the V-CSN, and send the location result to the V-CSN.

10. A connectivity service network (CSN), being a home domain CSN (H-CSN) that a user terminal belongs to, the CSN comprising:
a first receiving unit, configured to receive a location request sent by a client;
an authenticating unit, configured to authenticate the location request;
a first sending unit, configured to send the location request to a visited domain CSN (V-CSN) after the authentication succeeds;
a second receiving unit, configured to receive a location result returned by the V-CSN, wherein the location result is information obtained from location measurement by triggering a visited domain access service network (V-ASN) after the V-CSN sends the location request to the V-ASN; and
a second sending unit, configured to send the location result to the client.

11. The CSN according to claim 10, further comprising:
an obtaining unit, configured to obtain location capability information when the user terminal accesses the V-ASN or when the V-ASN switches, wherein the location capability information comprises at least one of: location capability of the user terminal, location capability of the V-ASN, and location capability of the V-CSN; and
a determining unit, configured to determine, according to the location capability information, whether the location request is satisfied, and if the location request is satisfied, trigger the authenticating unit to authenticate the location request; if the location request is not satisfied, return that the location fails.

12. The CSN according to claim 10, wherein
the location request received by the first receiving unit is a periodical location request, and the second receiving unit is configured to receive the location result, which is returned by the V-CSN according to a period of the location request, wherein the location result is the information obtained by the V-ASN, in the way of implementing location measurement according to the period, after receiving the periodical location request; and
the CSN further comprises: a terminating unit, configured to send a location termination request to the V-CSN, wherein the location termination request is used for the V-ASN to terminate the location measurement after the V-ASN receives the location termination request forwarded by the V-CSN.

13. The CSN according to claim 10, further comprising:
an accounting unit, configured to charge the location request according to a received accounting update request.
